(19) United States
(12) Patent Application Publication
(10) Pub. No.: US 2023/0422187 A1
(43) Pub. Date: Dec. 28, 2023

(54) ADJUSTING ANTENNA TRANSMISSION POWER

(71) Applicant: Hewlett-Packard Development Company, L.P., Spring, TX (US)

(72) Inventors: Cheng-Fang Lin, Taipei City (TW); Huai-Yung Yen, Taipei City (TW); Ruei-Ting Lin, Taipei City (TW); Ren-Hao Chen, Taipei City (TW); Lo-Chun Tung, Taipei City (TW); Sheng-Yen Chan, Taipei City (TW); Hsiao Chun Su, Taipei City (TW)

(21) Appl. No.: 17/850,053

(22) Filed: Jun. 27, 2022

(51) Int. Cl. H04W 52/36

(52) U.S. Cl. CPC H04W 52/367; H04W 84/12

(57) ABSTRACT

The transmission power at which to drive an antenna of a computing device is adjusted based on a peak transmission gain of the antenna for a current physical configuration mode in which the computing device is operating and on a maximum permitted radiation for the antenna. The antenna is driven at the adjusted transmission power when performing wireless communication using the antenna.

### BACKGROUND

Electronic devices, including convertible, laptop, and notebook computers, smartphones, tablet computing devices, and other types of electronic devices, commonly include wireless network connectivity capability. For example, such devices may have wireless local-area network (WLAN) capability to connect to networks like the Internet using Wi-Fi technology. The WLAN capability may permit an electronic device to communicate over multiple frequency bands, such as the 2.4 gigahertz (GHz), 5 GHz, and 6 GHz frequency bands. Electronic devices having these and other types of wireless network connectivity capability include antennas, which are often internal antennas, by which the devices wirelessly transmit and receive data.

### BRIEF DESCRIPTION OF THE DRAWINGS

FIG. 1 is a diagram of an example convertible computing device.

FIG. 2 is a table of example peak transmission gain of an antenna of a convertible computing device when used for wireless communication, in different physical configuration modes in which the computing device can operate.

FIG. 3 is a block diagram of constituent components of an example convertible computing device.

FIG. 4 is a diagram of an example process for adjusting the transmission power at which to drive an antenna of a convertible computing device based on the current physical configuration mode in which the computing device is operating.

FIG. 5 is a diagram of an example non-transitory computer-readable data storage medium.

FIG. 6 is a flowchart of an example method.

### DETAILED DESCRIPTION

As noted in the background section, electronic devices commonly include wireless network connectivity capability, such as wireless local-area network (WLAN) capability, by which the devices wirelessly transmit and receive data over multiple frequency bands, such as the 2.4 gigahertz (GHz), 5 GHz, and 6 GHz frequency bands, via antennas. Such electronic devices can include laptop or notebook computing, as well as convertible computing devices. A laptop, notebook, or convertible computing device includes an upper enclosure rotatable relative to a lower enclosure. The upper enclosure includes a display device, and the lower enclosure includes a keyboard and/or a pointing device (e.g., a touchpad).

The upper enclosure of a laptop or notebook computing device can rotate from zero degrees relative to the lower enclosure to a maximum rotation angle between 90 and 180 degrees. In the zero degree position, the upper enclosure is positioned against the lower enclosure such that the display, keyboard, and pointing device are hidden from view. In this position, the computing device may be able to be used in a physical configuration mode known as a clamshell mode. When the upper enclosure is rotated away from the lower enclosure, the computing device can be used in a physical configuration mode known as a notebook mode, in which the display is viewable and the keyboard and pointing device are usable.

By comparison, the upper enclosure of a convertible computing device can rotate from zero degrees relative to the lower enclosure to a maximum rotation angle that is least equal to 180 degrees and that is commonly 360 degrees. The physical configuration modes in which a convertible computing device therefore can include more than just the clamshell mode and/or the notebook mode. As one example, in the 360 degree position, the upper portion is positioned against the lower enclosure such that the display, keyboard, and pointing device are visible (as opposed to being hidden from view in the zero degree position). In this position, the computing device may be able to be used in a physical configuration mode known as a tablet mode.

When a computing device such as a laptop, notebook, or convertible computing device performs wireless communication, its antenna or antennas emit electromagnetic radiation (e.g., maximum radiated power). In general, the greater the electromagnetic radiation that an antenna emits, the better the range is in terms of how physically far away the computing device can be from another electronic device and still wirelessly communicate with the other device. Similarly, the greater the emitted radiation, the greater the speed is in terms of the data communication rate (e.g., bits per second, or bps) at which wireless communication can occur.

The transmission power at which the internal antenna of a computing device is driven is one factor that affects the amount of emitted electromagnetic radiation. Another factor that affects the amount of emitted electronic radiation is the transmission gain of the antenna. The transmission gain of the antenna is influenced by the design of the antenna, as well as its physical location within the computing device and its proximity to other electronic, electrical, metal, and other components both inside and outside the device that may affect gain. Another factor that influences the transmission gain of the antenna, and thus the amount of emitted electromagnetic radiation, is the current physical configuration mode in which the device is operating.

Regulating agencies govern the maximum electromagnetic radiation that can be transmitted for different frequency bands on a per-country or per-geographical region basis. The intent of these regulations is to minimize interference with other devices using the same bands, and maintain user safety even when devices are placed close to or in contact with end users' bodies for extended periods of time. Examples of such regulations include those that limit effective isotropic radiated power (EIRP) as well as those that limit external specific absorption rate (SAR). EIRP is the measured radiated power of an antenna in a specific direction. SAR is the measure of the rate at which energy is absorbed by the human body when exposed to a radio frequency (RF) electromagnetic field.

A laptop, notebook, or convertible computing device may have its antenna driven at a transmission power equal to the maximum permitted radiation (i.e., power) as specified by the regulations applicable in the physical location of the device, minus the nominal peak transmission gain of the antenna. This calculated transmission power ensures that the electromagnetic radiation emitted by the antenna does not exceed the maximum permitted radiation. Driving the antenna of the computing device at this calculated transmission power also ensures the widest range and greatest speed of the resulting wireless communication.

However, as noted above, the transmission gain of an antenna can also be influenced by the current physical configuration mode in which the computing device is operating. Considering the nominal peak transmission gain of the antenna apart from the current physical configuration mode of the device can result in the actual peak transmission gain of the antenna being higher or lower than nominal (and even negative). In the former case, the resulting amount of emitted electromagnetic radiation may exceed the amount permitted by regulation. In the latter case, wireless communication range and/or speed may be negatively affected, even though the antenna could be driven at a higher transmission power without running afoul of the maximum permitted amount.

Techniques described herein ameliorate these and other issues. The current physical configuration mode in which a computing device, such as a laptop, notebook, or convertible computer, is determined. The peak transmission gain of the antenna of the computing device is determined for the current physical configuration mode in which the device is operating. The transmission power at which to drive then antenna is then adjusted based on the peak transmission gain for the current physical configuration mode as well as on the maximum permitted radiation for the antenna. For example, the transmission power may be calculated by subtracting the peak transmission gain for the current mode from the maximum permitted radiation (i.e., power).

Therefore, the antenna of the computing device can be driven at a transmission power that ensures the widest wireless communication range and/or the greatest wireless communication speed while still conforming to any regulatory maximum permitted radiation, regardless of the current physical configuration mode. If the device is operating in a mode for which the peak transmission gain of the antenna is lower (or even negative), for instance, then transmission power will be increased to maintain maximum range and/or speed. By comparison, if the device is operating in a mode for which the peak transmission gain is higher, the transmission power will be decreased so as not to exceed the maximum permitted radiation.

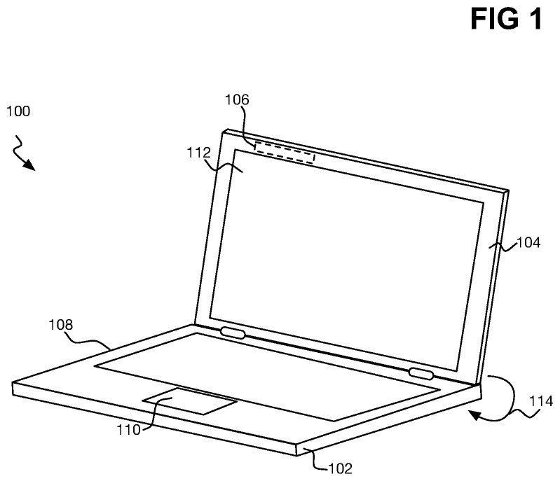

FIG. 1 shows an example computing device 100. The computing device 100 may be a laptop, notebook, or convertible computing device. The device 100 includes a first, lower enclosure 102 in which a keyboard 108 and/or a pointing device 110 such as a touchpad can be disposed. The device 100 includes a second, upper enclosure 104 in which an internal antenna 106 and a display device 112, such as a touchscreen display device, can be disposed. The display device 112 may be a flat panel display, such as a liquid crystal display (LCD) or an organic light-emitting diode (OLED) display.

The antenna 106 is displayed in a dashed line manner in the example to convey that the antenna 106 is not externally visible. The antenna 106 may be external instead of internal, or partially external and partially internal. There may be more than one antenna 106. The upper enclosure 104 is rotatably affixed to the lower enclosure 102, such as via one or multiple hinges, and can thus be rotated relative to the lower enclosure 102.

In the case in which the computing device 100 is a laptop or notebook computer, the upper enclosure 104 may be rotatable in a clockwise direction, per arrow 114, from zero degrees relative to the lower enclosure 102 to more than 90 but less than 180 degrees. In the case in which the computing device 100 is a convertible computer, the enclosure 104 may be rotatable in a clockwise direction from zero degrees relative to the enclosure 102 to at least 180 degrees if not 270 or a full 360 degrees. The current physical configuration mode in which the computing device 100 is operating depends on and thus corresponds to the current angle of rotation of the upper enclosure 104 relative to the lower enclosure 102.

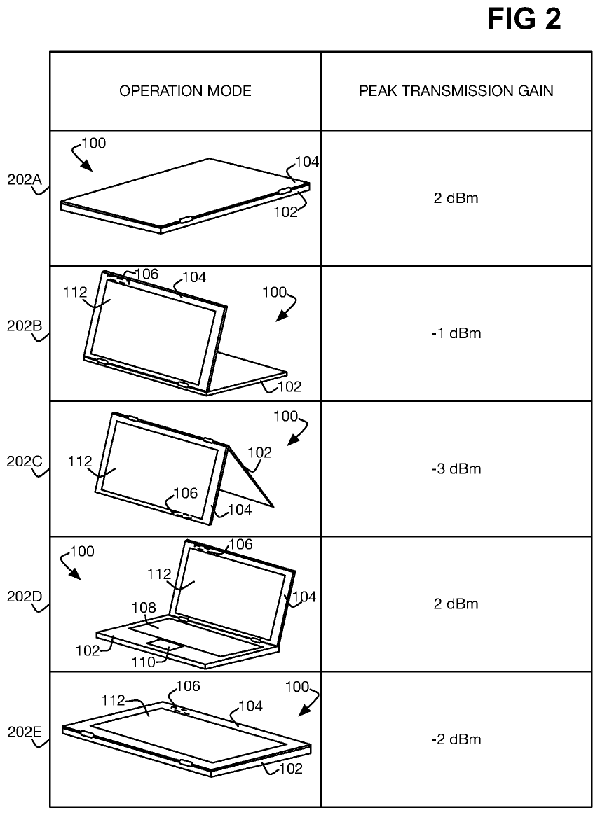

FIG. 2 shows example peak transmission gain of the antenna 106 for different physical configuration modes 202A, 202B, 202C, 202D, and 202E of the computing device 100. The physical configuration mode 202A is a clamshell mode, in which the computing device 100 may be operable regardless of whether it is a laptop, notebook, or convertible computer. The antenna 106 may have a peak transmission gain of 2 decibel-milliwatts (dBm) when the computing device 100 is operating in the clamshell mode. It is noted, though, that the peak transmission gain may be different for different frequency bands (e.g., 2.4 gigahertz (GHz) as opposed to 5 or 6 GHz).

In the physical configuration mode 202A, the upper enclosure 104 may not have been rotated relative to the lower enclosure 102. The upper enclosure 104 may be closed against the lower enclosure 102 such that the display device 112 faces the keyboard 108 and the pointing device 110, which are hidden from view. The computing device 100 may be operable in the operating mode 202A if the device 100 is communicatively connected to an external display device and an external input device, for instance. In the physical configuration mode 202A, the keyboard 108, the pointing device 110, and/or the display device 112 may be disabled.

The physical configuration mode 202B is a stand mode, in which the computing device 100 may be operable if it is a convertible computer as opposed to a laptop or notebook computer. The antenna 106 may have a peak transmission gain of −1 dBm (i.e., a negative gain) when the device 100 is operating in the stand mode. In the mode 202B, the upper enclosure 104 may be rotated between 270 and 360 degrees relative to the lower enclosure 102. The device 100 may rest on an external surface such as a desktop or tabletop such that the keyboard 108 and the pointing device 110, which are hidden from view, are adjacent to the desktop or tabletop. In the operating mode 202B, the keyboard 108 and/or the pointing device 110 may be disabled.

The physical configuration mode 202C is a tent mode, in which the computing device 100 may be operable if it is a convertible computer as opposed to a laptop or notebook computer. The antenna 106 may have a peak transmission gain of −3 dBm (i.e., a negative gain) when the device 100 is operating in the stand mode. In the mode 202C, the upper enclosure 104 may be rotated by more than 180 degrees relative to the lower enclosure 102. The device 100 may rest on an external surface such as a desktop or tabletop such that the display device 112 faces outwards, as do the keyboard 108 and the pointing device 110, which are hidden from view. In the mode 202C, the keyboard 108 and/or the pointing device 110 may be disabled.

The physical configuration mode 202D is a notebook mode in which the computing device 100 may be operable regardless of whether it is a laptop, notebook, or convertible. The antenna 106 may have a peak transmission gain of 2 dBm when the device is operating in the notebook mode. In the mode 202D, the upper enclosure 104 may be rotated at least 90 degrees relative to the lower enclosure 102. The device 100 may rest on the surface of the lower enclosure 102 opposite the keyboard 108 and the pointing device 110. In the mode 202D, the display device 112, the keyboard 108, and/or the pointing device 110 may be enabled.

The physical configuration mode 202E is a tablet mode in which the device 100 operates like a standalone tablet computing device. The computing device 100 may be operable in the mode 202E if it is a convertible computer as opposed to a laptop or notebook computer. The antenna 106 may have a peak transmission gain of −2 dBm when the device 100 is operating in the tablet mode. In the mode 202E, the upper enclosure 104 is fully rotated (e.g., 360 degrees) relative to the lower enclosure 102. The device 100 may rest on the surface of the lower enclosure 102 at which the keyboard 108 and the pointing device 110 (which are hidden from view) face outward. In the mode 202E, the keyboard 108 and/or the pointing device 110 may be disabled.

The physical configuration modes 202A, 202B, 202C, 202D, and 202E can be considered a set of physical configuration modes. A given computing device 100 may be operable in any of a limited number of these configuration modes 202A, 202B, 202C, 202C, 202D, and 202E, and thus in any of a subset of the complete set of physical configuration modes. For example, a laptop or notebook computer may be able to operate in just the mode 202D or in either of the modes 202A and 202D. By comparison, a convertible computer may be able to operate in any of three or more of the modes 202A, 202B, 202C, 202D, and 202E, including all of them.

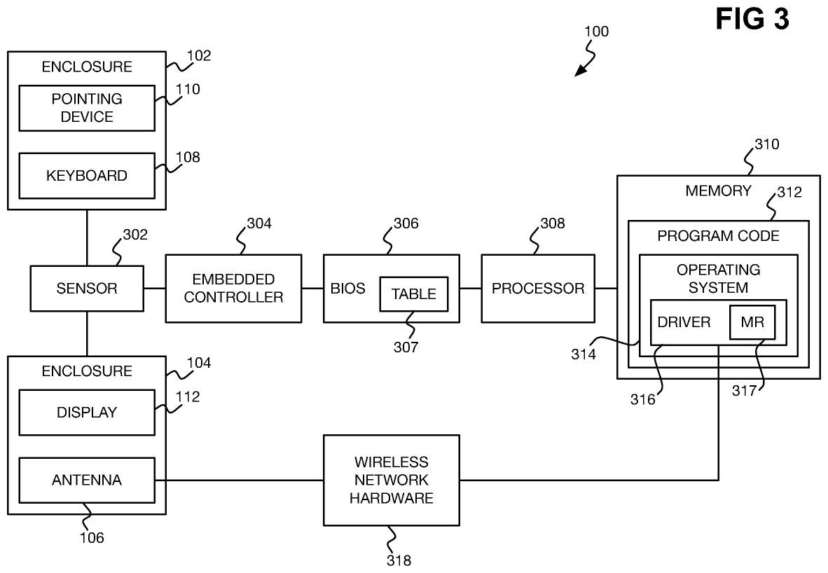

FIG. 3 shows the computing device 100 in example constituent-component detail. The computing device 100 can include components other than those shown. The computing device 100 includes the lower enclosure 102 housing the keyboard 108 and the pointing device 110 and the upper enclosure 104 housing the antenna 106 and the display device 100, as described. The device 100 can also include on or multiple sensors 302, such as Hall sensors. The sensors 302 can detect the position of the upper enclosure 104 relative to the lower enclosure 102, and thus the current angle of rotation of the enclosure 104 relative to the enclosure 102.

The computing device 100 includes an embedded controller 304, which may be an integrated circuit (IC), such as an application-specific IC (ASIC). The embedded controller 304 identifies the current physical configuration mode in which the device 100 is currently operating based on the current angle of rotation of the upper enclosure 104 relative to the lower enclosure 102. For example, each physical configuration mode may correspond a given rotation angle or a given rotation angle range. Therefore, by comparing the current rotation angle against these given rotation angle(s) and/or range(s), the embedded controller 304 is able to identify the corresponding configuration mode corresponding in which the device 100 is currently operating.

The computing device 100 includes a basic input/output system (BIOS) 306. The BIOS 306 may also be implemented as IC such as an ASIC. The BIOS 306 stores a table 307 having peak transmission gain-physical configuration mode entries, such as in correspondence with FIG. 2. For each physical configuration mode, therefore, there is a corresponding entry indicating the peak transmission gain of the antenna 106 when the device 100 is currently operating in that mode.

The computing device 100 includes a processor 308 and a memory 310 storing program code 312 executable by the processor 308. The memory may be a volatile semiconductor memory, such as a dynamic random access memory (DRAM). The program code 312 includes program code that realizes an operating system 314 on or in conjunction with which application and other computer programs can run. The operating system 314 includes a driver 316, which is installed in the operating system 314 so that a corresponding peripheral device is accessible by software such as application and other computer programs.

The driver 316 is specifically for wireless network hardware 318 of the computing device 100. The wireless network hardware 318 performs wireless communication using the antenna 106, and thus the hardware 318 may for data transmission drive the antenna 106 at a transmission power. The wireless network hardware 318 be a wireless network adapter implemented as one or multiple ICs including ASICs, on a primary logic board of the device 100 or a separate logic board. The wireless network driver 316 stores a maximum permitted radiation 317 that the antenna 106 is allowed to emit, which may be governed by regulations that differ by geographical area.

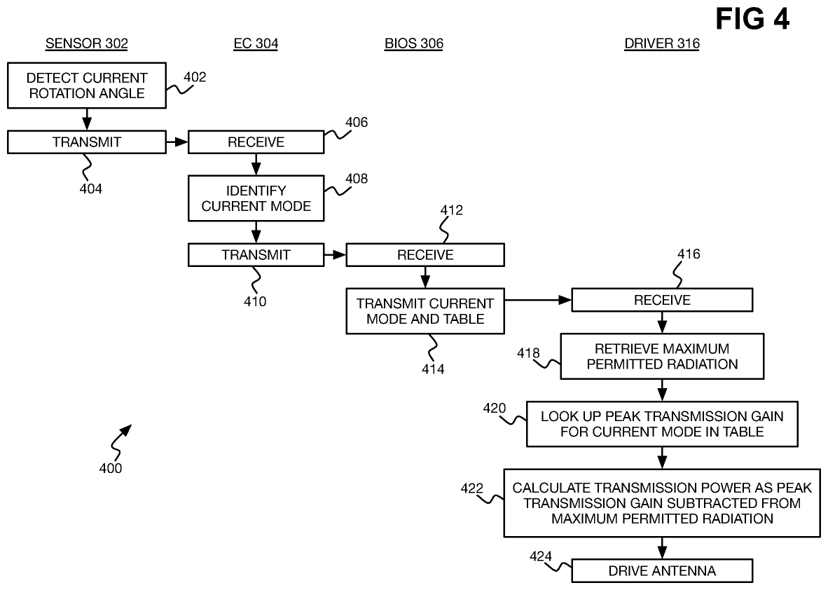

FIG. 4 shows an example process 400 for adjusting the transmission power at which to drive the antenna 106 based on the current physical configuration mode in which the computing device 100 is operating. The sensor 302 detects the current rotation angle of the upper enclosure 104 relative to the lower enclosure 102 (402), and may transmit it to the embedded controller 304 (404). The embedded controller 304 receives the current rotation angle (406) and identifies the current physical configuration mode corresponding to the current rotation angle (408).

The controller 304 may transmit the current physical configuration mode to the BIOS 306 (410). The BIOS 306 receives the current physical configuration mode (412) and may transmit it as well as the table 307 to the wireless network driver 316 (414), which receives both (416). The wireless network driver 316 may retrieve the maximum permitted radiation 317 of the antenna 106 (418), and look up in the table 307 the peak transmission gain of the antenna 106 for the current physical configuration mode in which the computing device 100 is operating (420).

The wireless network driver 316 can calculate the transmission power at which to drive the antenna 106 (422). For example, the transmission power may be calculated as the maximum permitted radiation 317 (i.e., maximum permitted power) minus the peak transmission gain (which may be negative) of the antenna 106 for the current physical configuration mode in which the device 100 is operating. The driver 316 then causes the wireless network hardware 318 to drive the antenna 106 at the calculated transmission power when performing wireless communication (e.g., specifically data transmission) (424).

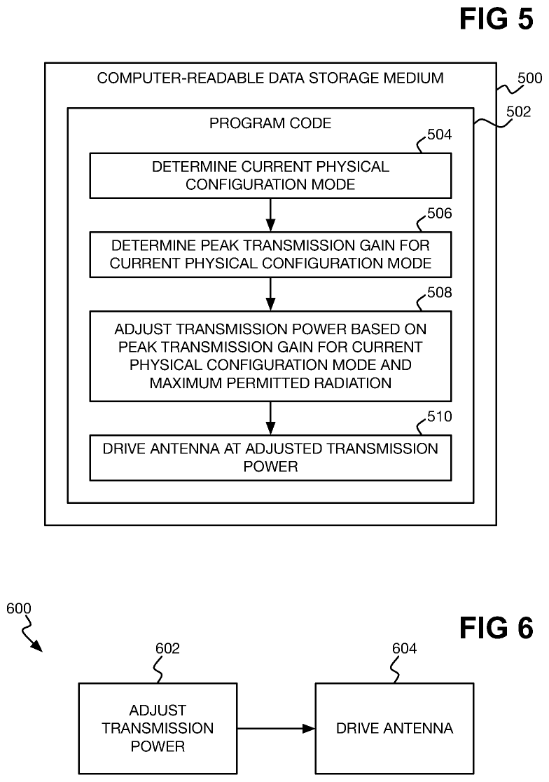

FIG. 5 shows an example non-transitory computer-readable data storage medium 500 storing program code 502, which may be operating system program code including wireless network driver program code. The program code 502 is executable by the processor 308 of the computing device 100 to perform processing. The data storage medium 500 may be the memory 310, in which case the program code 502 is the program code 312, or the program code 502 may be loaded from the data storage medium 500 into the memory 310 to become the program code 312.

The processing includes determining a current physical configuration mode in which the computing device 100 is operating (504). The processing includes determining a peak transmission gain of the antenna 106 of the computing device 100 for the current physical configuration mode (506). The processing includes adjusting the transmission power at which to drive the antenna 106 based on the peak transmission gain for the current physical configuration mode and on a maximum permitted radiation for the antenna (508). The processing includes driving the antenna 106 at the adjusted transmission power when performing wireless communication using the antenna (510).

FIG. 6 shows an example method 600. The method 600 may be performed by the computing device 100, such as by the wireless network driver 316 of the operating system 314 as may result when the processor 308 executes the program code 312 in the memory 310. The method 600 includes adjusting a transmission power at which to drive the antenna 106 of the computing device 100 based on a peak transmission gain of the antenna 106 for a current physical configuration mode in which the computing device 100 is operating and on a maximum permitted radiation for the antenna 106 (602). The method 600 includes driving the antenna 106 at the adjusted transmission power when performing wireless communication using the antenna 106 (604).

Techniques have been described for adjusting the transmission power at which to drive the antenna 106 of a computing device 100 according to the current physical configuration mode in which the device 100 is operating. The peak transmission gain of the antenna 106 depends on which of a number of physical configuration modes the computing device 100 is currently operating. Therefore, the transmission power can be accordingly adjusted to ensure that the maximum permitted radiation for the antenna 106 is not exceeded during wireless communication, while still providing for maximum wireless range and wireless communication speed.

We claim:

1. A non-transitory computer-readable data storage medium storing program code executable by a processor of a computing device to:
determine a current physical configuration mode in which the computing device is operating;
determine a peak transmission gain of an antenna of the computing device for the current physical configuration mode;
adjust a transmission power at which to drive the antenna based on the peak transmission gain for the current physical configuration mode and on a maximum permitted radiation for the antenna; and
drive the antenna at the adjusted transmission power when performing wireless communication using the antenna.

2. The non-transitory computer-readable data storage medium of claim 1, wherein the computing device is a laptop computing device, and the current physical configuration mode is determined as either a clamshell mode or a notebook mode.

3. The non-transitory computer-readable data storage medium of claim 1, wherein the computing device is a convertible computing device, and the current physical configuration mode is determined as either a clamshell mode, a notebook mode, a stand mode, a tent mode, or a tablet mode.

4. The non-transitory computer-readable data storage medium of claim 1, wherein the processor is to determine the current physical configuration mode in which the computing device is operating by:
retrieving the current physical configuration mode from a basic input/output system (BIOS) of the computing device as provided to the BIOS from an embedded controller of the computing device.

5. The non-transitory computer-readable data storage medium of claim 1, wherein the peak transmission gain of the antenna depends on which of different physical configuration modes the computing device is currently operating.

6. The non-transitory computer-readable data storage medium of claim 1, wherein the processor is to determine the peak transmission gain of the antenna for the current physical configuration mode by:
looking up the peak transmission gain of the antenna for the current physical configuration mode within a table stored in a basic input/output system (BIOS) of the computing device and having a plurality of peak transmission gain-physical configuration mode entries.

7. The non-transitory computer-readable data storage medium of claim 1, wherein the processor is to adjust the transmission power at which to drive the antenna by:
retrieving the maximum permitted radiation for the antenna; and
calculating the transmission power at which to drive the antenna by subtracting the peak transmission gain of the antenna for the current physical configuration mode from the maximum permitted radiation for the antenna.

8. The non-transitory computer-readable data storage medium of claim 1, wherein the program code comprises a wireless network driver of an operating system that performs the wireless communication using the antenna.

9. A computing device comprising:
a first enclosure having a keyboard and a pointing device;
a second enclosure having a display device and rotatable relative to the first enclosure, wherein a current physical configuration mode in which the computing device is operating is based on a current angle of rotation of the second enclosure relative to the first enclosure;
an antenna;
wireless network hardware to perform wireless communication using the antenna;
a processor; and
a memory storing program code executable by the processor to:
determine the current physical configuration mode in which the computing device is operating;
determine a peak transmission gain of the antenna for the current physical configuration mode;
adjust a transmission power at which the wireless network hardware is to drive the antenna based on the peak transmission gain for the current physical configuration mode and on a maximum permitted radiation for the antenna; and
cause the wireless network hardware to drive the antenna at the adjusted transmission power when performing wireless communication using the antenna.

10. The computing device of claim 9, wherein the computing device is a laptop computing device, and the current physical configuration mode is determined as either a clamshell mode or a notebook mode.

11. The computing device of claim 9, wherein the computing device is a convertible computing device, and the current physical configuration mode is determined as either a clamshell mode, a notebook mode, a stand mode, a tent mode, or a tablet mode.

12. The computing device of claim 9, further comprising:
one or multiple sensors to detect the current angle of rotation of the second enclosure relative to the first enclosure;
am embedded controller to receive the current angle of rotation from the sensors and to identify the current physical configuration mode corresponding to the current angle of rotation; and
a basic input/output system (BIOS) to receive the current physical configuration mode from the embedded controller.

13. The computing device of claim 12, wherein the program code comprises a wireless network driver of an operating system that is to determine the current physical configuration mode by retrieving the current physical configuration from the BIOS.

14. The computing device of claim 13, wherein the BIOS stores a table having a plurality of peak transmission gain-physical configuration mode entries,
wherein the program code is further executable by the processor to wireless network driver is to retrieve the table from the BIOS.

15. The computing device of claim 14, wherein the wireless network driver is to adjust the transmission power at which the wireless network hardware is to drive the antenna by:
looking up the peak transmission gain of the antenna for the current physical configuration mode within the table retrieved from the BIOS; and
calculating the transmission power at which the wireless network hardware is to drive the antenna by subtracting the peak transmission gain of the antenna for the current physical configuration mode from the maximum permitted radiation for the antenna.

16. A method comprising:
adjusting a transmission power at which to drive an antenna of a computing device based on a peak transmission gain of the antenna for a current physical configuration mode in which the computing device is operating and on a maximum permitted radiation for the antenna; and
driving the antenna at the adjusted transmission power when performing wireless communication using the antenna.

17. The method of claim 16, wherein the computing device is a laptop computing device, and the current physical configuration mode is determined as either a clamshell mode or a notebook mode.

18. The method of claim 16, wherein the computing device is a convertible computing device, and the current physical configuration mode is determined as either a clamshell mode, a notebook mode, a stand mode, a tent mode, or a tablet mode.

19. The method of claim 16, wherein the peak transmission gain of the antenna depends on the current physical configuration mode in which the computing device is operating,
and wherein the transmission power at which to drive the antenna is calculated by subtracting the peak transmission gain of the antenna for the current physical configuration mode from the maximum permitted radiation for the antenna.

20. The method of claim 16, wherein the transmission power at which to drive the antenna is adjusted by a wireless network driver of an operating system of the computing device.
